(19) United States
(12) Patent Application Publication
(10) Pub. No.: US 2010/0060081 A1
(43) Pub. Date: Mar. 11, 2010

(54) System and Method for Providing Power to Portable Electronic Devices

(75) Inventors: Edwin Cheong, Bellingham, WA (US); Grant Lange, Mandeville, LA (US); Greg Janky, Sammamish, WA (US); Fisher Laura, Burlington, WA (US)

Correspondence Address: SCHACHT LAW OFFICE, INC., SUITE 202, 2801 MERIDIAN STREET, BELLINGHAM, WA, 98225-2412, US

(73) Assignee: ALLSOP, INC., Bellingham, WA (US)

(21) Appl. No.: 12/554,776

(22) Filed: Sep. 4, 2009

Related U.S. Application Data
(60) Provisional application No. 61/191,093, filed on Sep. 4, 2008.

(51) Int. Cl. H02J 4/00

(52) U.S. Cl. 307/66

(57) ABSTRACT

A power supply for an electronic device comprises a power module, an AC module, and a DC module. The power supply operates in first and second configurations. In the first configuration, the power module generates a DC output signal based on an AC power signal transmitted from the AC module. In the second configuration, the power module generates the DC output signal based on a DC power signal from the DC module.

### RELATED APPLICATIONS

This application (Attorney's Ref. No. P215766) claims priority of U.S. Provisional Application Ser. No. 61/191,093 filed Sep. 4, 2008, the contents of which are incorporated herein by reference.

### TECHNICAL FIELD

The present invention relates to the systems and methods for providing power to portable electronic devices and, more particularly, such systems and methods that allow power to be obtained from different power sources and provided to portable electronic devices having different power signal requirements.

### BACKGROUND

Portable electronic devices are typically designed to be used in a number of operating environments. To increase the variety of operating environments in which such devices may be used, the devices are often equipped with disposable and/or rechargeable batteries. Typically, portable electronic devices designed to operate off of battery power may also be alternatively operated using site power available in a particular operating environment. Site power may either be an AC power source such as utility power or a DC power source such as the power system of a vehicle.

Because a battery powered electronic device typically uses a low voltage DC power signal, an AC site power signal must be converted to an appropriate DC power signal. To save space and weight in the portable electronic device, the converter device for converting the AC site power signal to the low voltage DC power signal is located in a separate enclosure. Typically, the enclosure of the converter device is connected to the portable electronic device using a DC power cable capable of carrying the low voltage DC power signal. A connector system physically and electrically connects the DC power cable to the portable electronic device. To take advantage of site DC power, a cable and/or converter device may be required to transfer an appropriate DC power signal form the site DC power source

Currently, portable electronic devices employ a variety of types of converter devices, cables, and connector systems that are often incompatible is with each other. Accordingly, a user of more than one portable electronic device often carries different converter devices and connector systems to allow the portable electronic device to take advantage of utility power in a wide range of operating environments.

The need thus exists for improved power supplies for portable electronic devices that increase access to power sources available in a variety of operating environments, reduce the number of converter devices and related cables that must be carried by a typical user, and organize the cables associated with connecting portable electronic devices to utility or other power sources.

### SUMMARY

The present invention may be embodied as a power supply for an electronic device comprising a power module, an AC module, and a DC module. The power module comprises a first housing assembly, an output cable assembly, and a first power connector. The AC module comprises a second housing assembly, an AC cable assembly, and a second power connector. The DC module comprises a third housing assembly, a DC cable assembly, and a third power connector. The power supply operates in first and second configurations. In the first configuration, the first and second housing assemblies are detachably attached such that the first and second power connectors are electrically connected, an AC power signal present on the AC cable assembly is transmitted to the Power module through the first and second power connectors, the power module generates a DC output signal on the output cable assembly based on the AC power signal transmitted through the first and second power connectors, and the output cable assembly is electrically connected to the electronic device. In the second configuration, the first and third housing assemblies are detachably attached such that the first and third power connectors are electrically connected, a DC power signal present on the DC cable assembly is transmitted to the power module through the first and third power connectors, the power module generates the DC output signal on the output cable assembly based on the DC power signal transmitted through the first and third power connectors, and the output cable assembly is electrically connected to the electronic device.

The present invention may also be configured as a power supply for an electrical device comprising a power module, an AC module, and a DC module. The power supply operates in first and second configurations.

The power module comprises a first housing assembly, an output cable assembly, a first power connector, and at least one first circuit board. The at least one first circuit board contains an AC to DC converter operably connected between the first power connector and the output cable assembly and a DC to DC converter operably connected between the first power connector and the output cable assembly.

The AC module comprises a second housing assembly, an AC cable assembly, a second power connector, and at least one second circuit board containing a filter circuit operably connected between the AC cable assembly and the second power connector. The DC module comprises a third housing assembly, a DC cable assembly, a third power connector, and at least one third circuit board comprising a boost converter operably connected between the DC cable assembly and the third power connector.

In the first configuration, the first and second housing assemblies are detachably attached such that the first and second power connectors are electrically connected, an AC power signal present on the AC cable assembly is transmitted to the power module through the first and second power connectors, the AC to DC converter generates a DC output signal on the output cable assembly based on the AC power signal transmitted through the first and second power connectors, and the output cable assembly is electrically connected to the electronic device.

In the second configuration, the first and third housing assemblies are detachably attached such that the first and third power connectors are electrically connected, a DC power signal present on the DC cable assembly is transmitted to the power module through the first and third power connectors, the DC to DC converter generates the DC output signal on the output cable assembly based on the DC power signal transmitted through the first and third power connectors, and the output cable assembly is electrically connected to the electronic device.

### BRIEF DESCRIPTION OF THE DRAWINGS

FIG. 1 is a perspective view of a first configuration of a first example power system of the present invention;

FIG. 2 is a perspective view of a second configuration of the first example power system of the present invention;

FIG. 3 is a top perspective view of a first example power module of the first example power system of the present invention;

FIG. 4 is an exploded view of the first example power module;

FIG. 5 is a top plan view of the first example power module;

FIG. 6 is a side elevation view of the first example power module taken along lines 6-6 in FIG. 5;

FIG. 7 is a section view of the first example power module taken along lines 7-7 in FIG. 5;

FIG. 8 is a top perspective view of a first example AC module of the first example power system of the present invention;

FIG. 9 is an exploded view of the first example AC module;

FIG. 10 is a top plan view of the first example AC module;

FIG. 11 is a side elevation view of the first example AC module taken along lines 11-11 in FIG. 10;

FIG. 12 is a section view of the first example AC module taken along lines 12-12 in FIG. 10;

FIG. 13 is a top perspective view of a first example DC module of the first example power system of the present invention;

FIG. 14 is an exploded view of the first example DC module;

FIG. 15 is a top plan view of the first example DC module;

FIG. 16 is a side elevation view of the first example DC module taken along lines 16-16 in FIG. 15;

FIG. 17 is a section view of the first example DC module taken along lines 17-17 in FIG. 15;

FIG. 18 is a section view of the first configuration of the first example power system as depicted in FIG. 1;

FIG. 19 is a section view of the second configuration of the first example power system as depicted in FIG. 2;

FIG. 20A is a top perspective view of a first example battery module that may be used with a power system of the present invention;

FIG. 20B is a bottom perspective view of the first example battery module;

FIG. 21A is a top perspective view of a first example USB module that may be used with a power system of the present invention;

FIG. 21B is a bottom perspective view of the first example USB module;

FIG. 22 is a perspective view of a portion of a first configuration of a second example power system of the present invention;

FIG. 23 is a perspective view of the first configuration of the second example power system of the present invention;

FIG. 24 is a perspective view of a first example control module that may be used in conjunction with a power system of the present invention;

FIG. 25 is a perspective view of another configuration of an example power system of the present invention employing a power module, battery module, and AC module;

FIG. 26 is a perspective view of another configuration of an example power system of the present invention employing a power module, battery module, and DC module;

FIG. 27 is a perspective view of another configuration of an example power system of the present invention employing a power module, battery module, USB module, and AC module;

FIG. 28 is a perspective view of another configuration of an example power system of the present invention employing a power module, battery module, USB module, and DC module;

FIG. 29 is a perspective view of another configuration of an example power system of the present invention employing a power module, USB module, battery module, and AC module;

FIG. 30 is a perspective view of another configuration of an example power system of the present invention employing a power module, USB module, battery module, and DC module;

FIG. 31 is a perspective view of an example power module of the present invention illustrating a storage system for storing one or more adapter tips;

FIG. 32 is a front elevation view of the example power module depicted in FIG. 31;

FIG. 33 is a schematic block diagram of a first configuration of an example supply of the present invention;

FIG. 34 is a schematic block diagram of a second configuration of an example supply of the present invention;

FIG. 35 is a schematic block diagram of a third configuration of an example power supply of the present invention;

FIG. 36 is a schematic block diagram of a fourth configuration of an power supply of the present invention;

FIG. 37 is a schematic block diagram of the first example power supply as depicted in FIGS. 1 and 2; and

FIG. 38 is a schematic block diagram showing certain details of an example power module that may be used by the first example power supply as depicted in FIG. 37.

### DETAILED DESCRIPTION

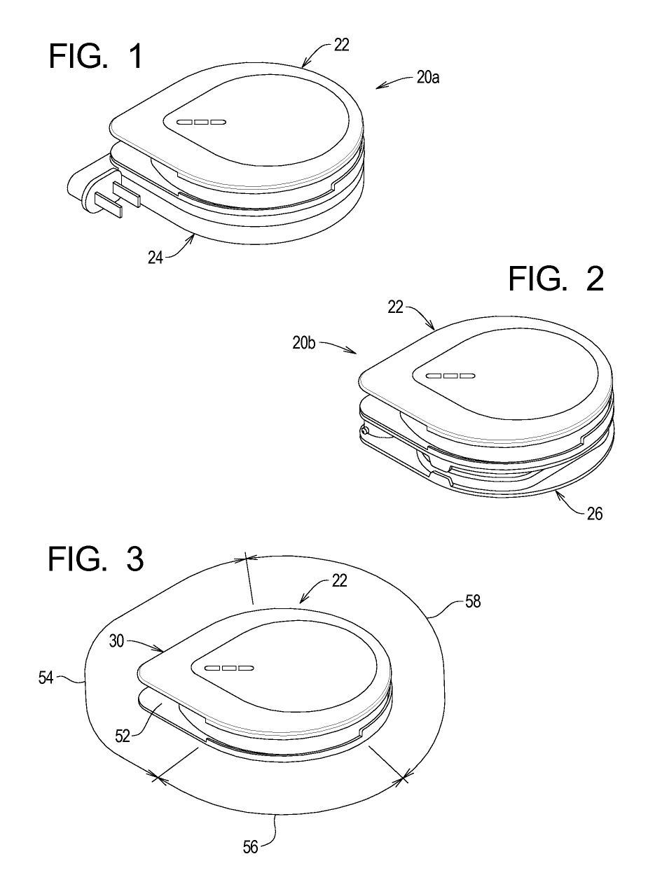

Referring initially to FIGS. 1 and 2, depicted therein is a first example power system constructed in accordance with, and embodying, the principles of the invention. The first example power system exists in two mutually exclusive configurations: a first configuration 20a is depicted in FIG. 1, and a second configuration 20b is depicted in FIG. 2.

In the first configuration 20a, the first example power system comprises a power module 22 and an AC module 24. The first configuration of the power system 20a generates a power signal suitable for a portable electronic device (not shown) based on an AC power signal such as a utility power source. In the second configuration 20b, the first example power system comprises the power module 22 and a DC module 26. The second configuration of the power system 20b generates a power signal suitable for a portable electronic device (not is shown) based on a DC power signal such as the electrical system of a vehicle. The power module 22, AC module 24, and DC module 26 are separate devices, and either the AC module 24 or the DC module 26 may be physically attached and electrically connected to the power module 22 as will be described in further detail below.

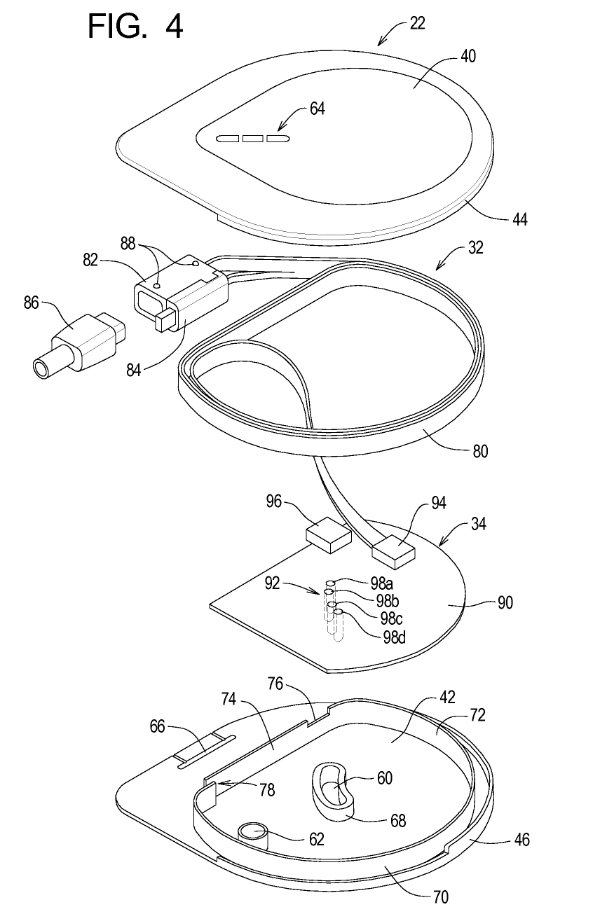

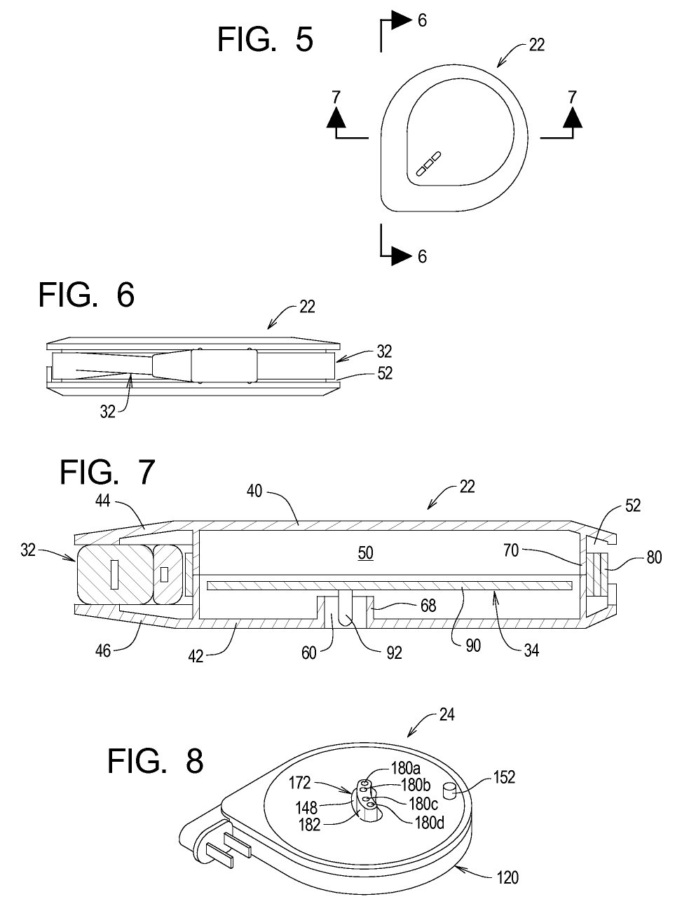

Referring now to FIGS. 3-7, the example power module 22 will be described in further detail. As perhaps best shown in FIG. 4, the example power module 22 comprises a first housing assembly 30, an output cable assembly 32, and a first circuit board assembly 34.

The first housing assembly 30 comprises a first part 40 and a second part 42 that define a first flange 44 and a second flange 46, respectively. The first and second parts 40 and 42 are joined to define the first housing assembly 30. The first housing assembly 30 defines a main chamber 50 (FIG. 7), and a perimeter slot 52 (FIGS. 3, 6, and 7). The perimeter slot 52 defines a first portion 54, a second portion 56, and a third portion 58.

A connector port 60 and a handle opening 62 are formed in the second part 42. One or more status lights 64 are visible through openings in the first part 40. As shown in FIG. 4, a docking slot 66 is formed on each of the parts 40 and 42, but only the docking slot on the second part 42 is visible in the drawing. A guide wall 68 extends from the second part 42 around the connector port 60.

As shown in FIG. 7, the first housing assembly 30 further defines a perimeter wall 70. As suggested in FIG. 4, the perimeter wall 70 comprises a curved portion 72 and a straight portion 74; an example USB port 76 is formed in the straight portion 74 of the perimeter wall 70, but can be formed elsewhere on the first housing assembly 30. Also as suggested in FIG. 4, a cable opening 78 is also formed in the perimeter wall 70.

The output cable assembly 32 comprises a cable 80 that terminates at a first end in a first connector 82 and a second connector 84. The first and second connectors 82 and 84 may be directly connected to first and second types of electronic devices, or an adapter 86 may be connected to the first connector 82 to accommodate the connector style of a third type of electronic device. It will be apparent that multiple adapters such as the adapter 86 may be provided, and the adapter that matches a particular type of electronic device may be selected and connected to the first connector 82 and/or second connector 84.

Docking projections 88 are formed on the first connector 82 to engage the docking slots 66 and maintain the first and second connectors 82 and 84 within the perimeter slot 52 when the cable assembly 32 is not in use. In addition, the first portion 54 of the perimeter slot 52 is wider to allow the connectors 82 and 84 to fit at least partly within the slot 52. The second portion 56 of the perimeter slot 52 is slightly narrower than the first portion 54 but slightly wider than the third portion 58 to facilitate winding of the output cable 80 within the perimeter slot 52 around the perimeter wall 70. The narrower third portion 58 is narrower than a width dimension of the output cable 80 to help maintain the output cable 80 within the perimeter slot 52 when the cable 80 is stored.

As shown in FIG. 4, the first circuit board assembly 34 comprises a first circuit board 90, a first power connector 92, a cable connector 94, and a USB connector 96. The first circuit board assembly 34 is illustrated as comprising a single circuit board 90 for purposes of clarity, but more than one circuit board may be used as appropriate.

As perhaps best shown in FIG. 7, the first circuit board 90 (and any additional circuit board) is adapted to be supported by the first housing assembly 30 within the main chamber 50. The first circuit board 90 will also contain other circuitry that can be more readily described with reference to block and/or schematic diagrams. A second end of the cable 80 terminates in the cable connector 94. The USB connector 96 is mounted on the board 90. The example first power connector 92 comprises four electrical contacts 98a, 98b, 98c, and 98d.

With the first circuit board 90 properly supported within the main chamber 50 by the first housing assembly 30, the first power connector 92 extends through the connector port 60 in the first housing assembly 30 (FIG. 7), the cable 80 passes through the cable opening 78 in the perimeter wall 70, and the USB connector 96 is accessible through the USB port 76 formed in the perimeter wall 70.

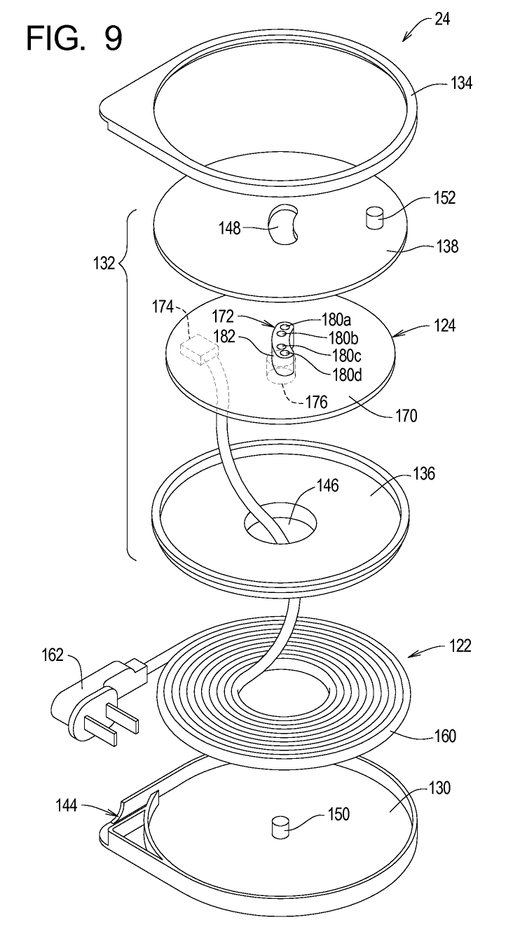

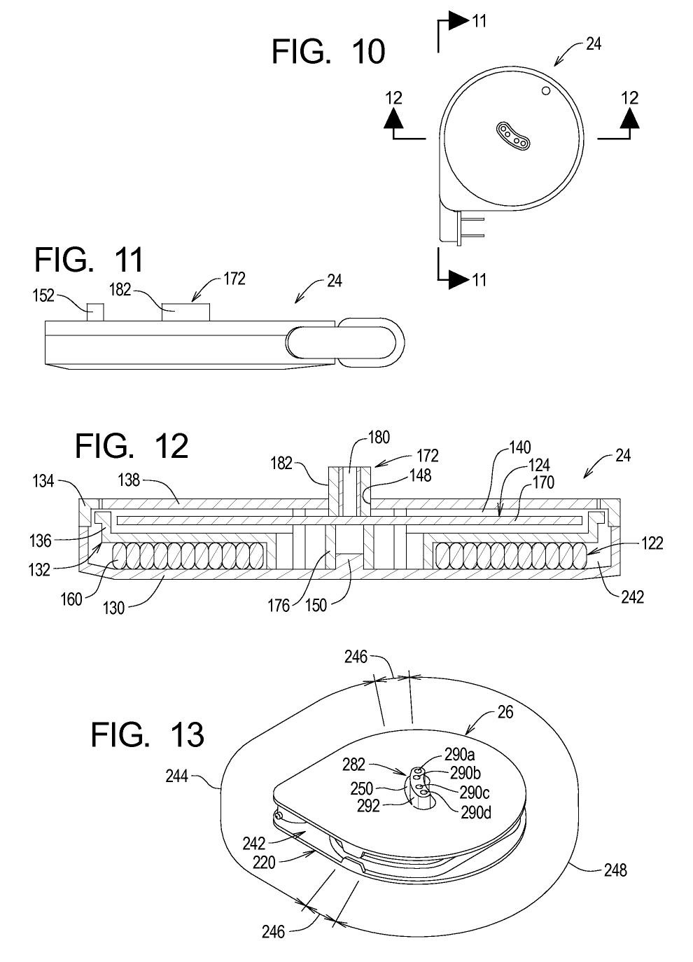

Referring now to FIGS. 8-12, the example AC module 24 will be described in further detail. As perhaps best shown in FIG. 9, the example AC module 24 comprises a second housing assembly 120, an A/C cable assembly 122, and a second circuit board assembly 124.

The second housing assembly 120 comprises a base part 130, a tray assembly 132, and a retainer part 134. The assembly 132 comprises a tray part 136 and tray cover part 138, and the retainer part 134 engages the base part 130 to support the tray assembly 132 relative to the base part 130. So supported, the tray assembly 132 is rotatable relative to the base part 130 and the retainer part 134.

As shown in FIG. 12, the tray assembly 132 defines a tray chamber 140 (FIG. 12), and a cable chamber 142 is formed between the tray assembly 132 and the base part 130. When joined together, the base part 130 and the retainer part 134 define a cable opening 144. An access opening 146 is formed in the tray part 136. FIGS. 9 and 12 illustrate a connector opening 148 formed in the tray cover part 138. FIGS. 9 and 11 illustrate a first hub projection 150 formed on to the base part 130 and a handle projection 152 formed on the tray cover part 138.

As perhaps best shown in FIG. 9, the NC cable assembly 122 comprises an A/C cable 160 and a plug connector 162 attached to a first end of the NC cable 160. The plug connector 162 is adapted to be mechanically attached and electrically connected to a standard utility outlet; the plug connector 162 may is thus take various forms depending upon the particular style of utility outlet available.

The second circuit board assembly 124 comprises a second circuit board 170, a second power connector 172, a cable connector 174, and a hub socket 176. As perhaps best shown in FIG. 12, the second circuit board 170 is adapted to be supported by the tray assembly 132 within the tray chamber 140. The second circuit board 170 may also contain other circuitry that can be more readily described with reference to block and/or schematic diagrams. A second end of the cable 160 terminates at the cable connector 174. The hub socket 176 receives the hub projection 150 to center the tray assembly 132 as the tray assembly rotates relative to the base part 130 within the cable chamber 142.

The second power connector 172 defines first, second, third, and fourth contact openings 180a, 180b, 180c, and 180d. The second power connector 172 further defines an exterior guide surface 182.

With the second circuit board 170 properly supported within the tray chamber 140 by the tray assembly 132, the second power connector 172 extends through the connector opening 148 in the tray cover part 138 (FIG. 12) and the NC cable 160 passes through the cable opening 144 defined by the second housing assembly 120. Pulling the plug connector 162 causes the tray assembly 132 to rotate relative to the base part 130 and the retainer part 134 such that the cable 160 is unwound from the hub socket 176 and extended from the second housing assembly 120. To retract the A/C cable 160 into the second housing assembly 120, the base part 130 is gripped in one hand, the handle projection 152 is gripped in the other hand, and the handle projection 152 is displaced to rotate the tray assembly 132 relative to the base part 130 and reel the cable 160 into the cable chamber 142 around the hub socket 176.

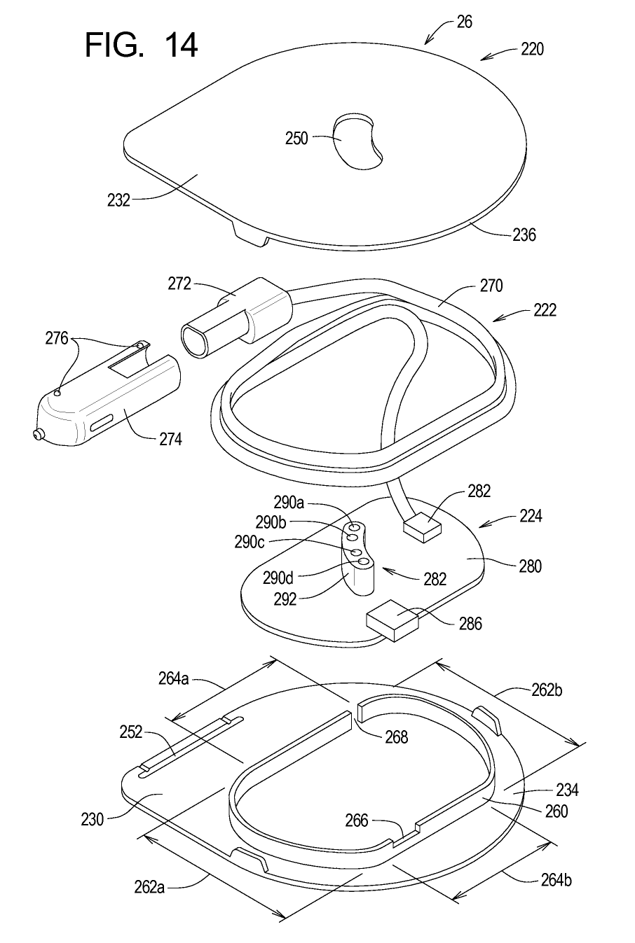

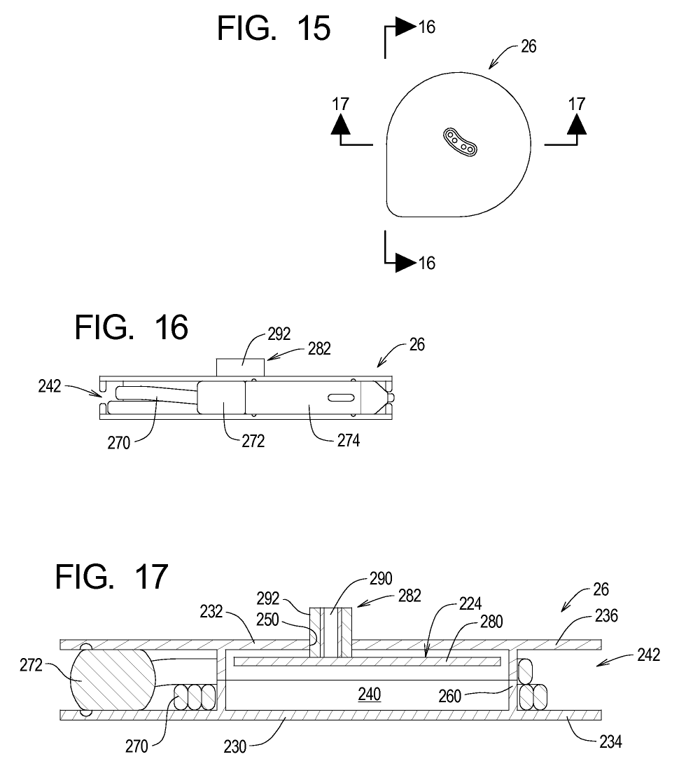

Referring now to FIGS. 13-17, the example DC module 26 will be described in further detail. As perhaps best shown in FIG. 14, the example DC module 26 comprises a third housing assembly 220, a DC cable assembly 222, and a third circuit board assembly 224.

The third housing assembly 220 comprises a first part 230 and a second part 232 that define a first flange 234 and a second flange 236, respectively. The first and second parts 230 and 232 are joined to define the third housing assembly 220. The third housing assembly 220 defines a main chamber 240 (FIG. 17), and a perimeter slot 242 (FIGS. 13, 16, and 17). The perimeter slot 242 defines a first portion 244, a pair of second portions 246, and a third portion 248.

A connector port 250 is formed in the second part 232. As shown in FIG. 14, a docking slot 252 is formed on each of the parts 230 and 232, but only the docking slot on the first part 230 is visible in the drawing. As shown in FIG. 17, the third housing assembly 220 further defines a perimeter wall 260. As suggested in FIG. 14, the perimeter wall 260 comprises curved portions 262a and 262b and straight portions 264a and 264b; a USB port 266 is formed in the straight portion 264b of the perimeter wall 260. Also as suggested in FIG. 14, a cable opening 268 is also formed in the perimeter wall 260.

The output cable assembly 222 comprises a DC cable 270 that terminates at a first end in a DC connector 272. The DC connector 272 may be directly connected to a first type of DC outlet, or an adapter 274 may be connected to the DC connector 272 to accommodate the connector style of a second type of DC outlet. It will be apparent that multiple adapters such as the adapter 274 may be provided, and the adapter that matches a particular type of DC outlet may be selected and connected to the DC connector 272.

Docking projections 276 are formed on the adapter 274 to engage the docking slots 252 and maintain the DC connector 272 and the adapter 274 within the perimeter slot 242 when the cable assembly 222 is not in use. The first portion 244 of the perimeter slot 242 is sufficiently wide to allow the DC connector 272 and adapter 274 to be inserted into the perimeter slot 242. The second portions 246 are narrowed to allow the DC cable 270 to be wound into the perimeter slot 242 around the perimeter wall 260 but to inhibit movement of the DC cable 270 out of the perimeter slot 242 when at least a portion of the cable 270 is stored. The third portion 248 of the perimeter slot 242 is wider than the second portions 246 to reduce interference with winding of the cable 270 into the perimeter slot 242.

As shown in FIG. 14, the third circuit board assembly 224 comprises a third circuit board 280, a third power connector 282, a cable connector 284, and a USB connector 286. As perhaps best shown in FIG. 17, the third circuit board 280 is adapted to be supported by the third housing assembly 220 within the main chamber 240. The third circuit board 280 will also contain other circuitry that can be more readily described with reference to block and/or schematic diagrams. A second end of the cable 270 terminates in the cable connector 284. The USB connector 286 is mounted on the board 280.

The third power connector 282 defines first, second, third, and fourth contact openings 290a, 290b, 290c, and 290d. The third power connector 282 further defines an exterior surface 292.

With the third circuit board 280 properly supported within the main chamber 240 by the third housing assembly 220, the third power connector 282 extends through the connector port 250 in the third housing assembly 220 (FIG. 14), the cable 270 passes through the cable port 268 in the perimeter wall 260, and the USB connector 286 is accessible through the USB port 266 formed in the perimeter wall 260.

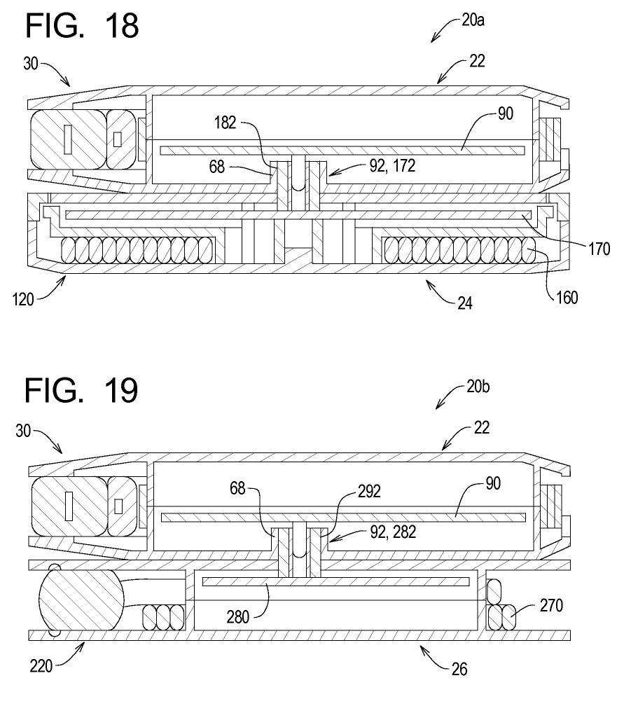

Referring now to FIGS. 18 and 19 of the drawing, the first and second configurations 20a and 20b of the power system 20 will now be described in further detail.

In the first configuration, the first power connector 92 of the power module 22 engages the second power connector 172 of the AC module 24 to form an electrical connection between the first circuit board 90 and the second circuit board 170. The first power connector 92 and second power connector 172 further form a friction or interference fit that mechanically attaches the AC module 24 to the power module 22. In addition, a friction fit can be formed between the guide wall 68 of the power module 22 and the guide surface 182 of the second power connector 172 of the AC module to enhance the mechanical attachment between the AC module 24 and the power module 22.

Further, the guide wall 68 and the guide surface 182 define compatible, asymmetrical shapes to ensure proper electrical connection between the first power connector 92 and the second power connector 172 as described below.

The example first and second power connectors 92 and 172 take the form of an arc or short curved segment. The handle opening 62 is arranged in the first housing assembly 30 to receive the handle projection 152 extending from the second housing assembly 120 when the power system is in the first configuration 20a.

In addition, the first and second housing assemblies 30 and 120 define similar asymmetrical shapes, and, when the first power connector 92 and second power connector 172 are connected, the example first and second housing assemblies 30 and 120 are aligned. In particular, the housing assemblies 30 and 120 are both generally circular through an angle of approximately 270°, with a pointed projection extending through the remaining angle of approximately 90°. The pointed projections of the housing assemblies 30 and 120 are substantially aligned when the system is in the first configuration 20a. The pointed projection on the first housing assembly 30 further increases the volume within the first portion 54 of the perimeter slot 52 to facilitate storage of the connectors 82 and 84 and adapter 86 within that slot 52.

In the example power system 20 with the AC module 24 having a tray assembly 132 that allows the AC cable assembly 122 to be wound within the second housing assembly 120, the first and second housing assemblies 30 and 120 can be rotated relative to each other with the power system in the first configuration 20a. Depending upon how much of the AC cable assembly 122 is extended from the tray assembly 132, the housing assemblies 30 and 120 may be misaligned from each other. In this context, relative rotation in one direction dispenses the AC cable assembly 122, while relative rotation in an opposite direction retracts the AC cable assembly 122. Accordingly, it should be apparent that, instead of gripping the handle projection 152 to rotate the tray assembly 132 relative to the base part 130, when the power system 20 is in the first configuration 20a, the power module 22 may be gripped and rotated relative to the AC module 24 to retract the AC cable assembly 122.

With the power system in the first configuration 20a and the plug connector 162 inserted into a compatible wall socket, power flows from the plug connector 162, through the AC cable 160, through the cable connector 174, through any circuitry on the second circuit board 170 connected between the cable connector 174 and the second power connector 172, through the electrical contact openings 180a and 180d of the second power connector 172, through the electrical contacts 98a and 98d of the first power connector 92, through any circuitry between the first power connector 92 and the cable connector 94, through the output power cable 80, through the first and/or second connectors 82 and 84 and any adapter 86 connected thereto, and into an electronic device connected to the connectors 82 and 84 and/or any adapter 86.

In the second configuration 20b, the first power connector 92 of the power module 22 engages the third power connector 282 of the DC module 26 to form an electrical connection between the first circuit board 90 and the third circuit board 280. The first power connector 92 and third power connector 282 further form a friction or interference fit that mechanically attaches the DC module 26 to the power module 22. In addition, a friction fit can be formed between the guide wall 68 of the power module 22 and the guide surface 292 of the third power connector 282 of the DC module to enhance the mechanical attachment between the DC module 26 and the power module 22.

Further, the guide wall 68 and the guide surface 292 define compatible, asymmetrical shapes to ensure proper electrical connection between the first power connector 92 and the third power connector 282 as described below. The example first and third power connectors 92 and 282 take the form of an arc or short curved segment.

In addition, the first and third housing assemblies 30 and 220 define similar asymmetrical shapes, and, when the first power connector 92 and third power connector 282 are connected, the example first and third housing assemblies 30 and 220 are aligned. In particular, the housing assemblies 30 and 220 are both generally circular through an angle of approximately 270°, with a pointed projection extending through the remaining angle of approximately 90°. The pointed projections of the housing assemblies 30 and 220 are substantially aligned when the system is in the second configuration 20b. The pointed projection on the third housing assembly 220 further increases the volume within the first portion 244 of the perimeter slot 242 to facilitate storage of the DC connector 272 and adapter 274 within that slot 242.

With the power system in the second configuration 20b and the DC connector 272 inserted directly or through an adapter 274 into a compatible DC socket, power flows to the plug connector 272 (through the adapter 274 if used), to through the DC cable 270, through the cable connector 284, through any circuitry on the third circuit board 280 connected between the cable connector 284 and the third power connector 282, through the electrical contact openings 290b and 290c of the third power connector 282, through the electrical contacts 98b and 98c of the first power connector 92, through any circuitry between the first power connector 92 and the cable connector 94, through the output power cable 80, through the first and/or second connectors 82 and 84 and any adapter 86 connected thereto, and into an electronic device connected to the connectors 82 and 84 and/or any adapter 86.

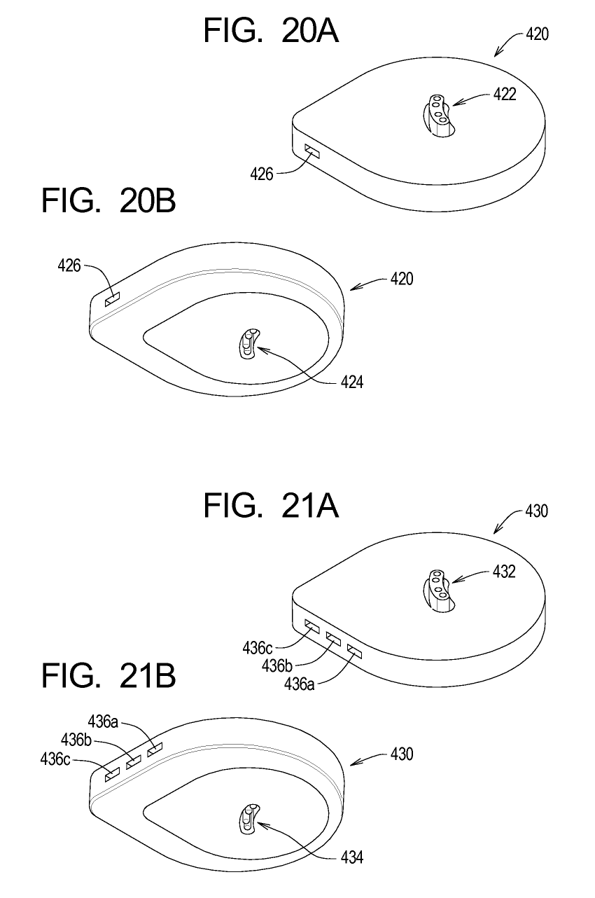

Turning now to FIGS. 20A and 20B, depicted at 420 therein is an optional battery module that may be used as part of a power system of the present invention. The example battery module 420 is constructed to be compatible with the power module 22, AC module 24, and/or DC module 26 described above.

The example battery module 420 comprises one or more disposable or rechargeable batteries (not shown in FIGS. 20A and 20B). In the case of disposable batteries, the battery module 420 need only have a battery output connector 422. In the case of rechargeable batteries, the battery module 420 may be provided with the battery output connector 422 and a battery input connector 424. In either case, the battery output connector 422 is adapted to engage the first power connector 92 of the power module 22 to provide DC power to the circuitry within the power module 22 in a manner similar to that of the second configuration 20b described above. The battery module 420 may also be configured to have a USB connector 426 for use with USB cables and compatible electronic devices.

If the batteries are rechargeable and the battery input connector 424 is provided, the battery input connector 424 is configured to receive the second power connector 172 of the AC module 24 and/or the third power connector 282 of the DC module 26. Circuitry within the battery module 420 can be configured to recharge the rechargeable batteries using the output of the AC module 24 and/or the output of the DC module 26. If power is supplied by the DC module 26, the circuitry within the battery module 420 can be configured to pass the DC power signal from the DC module 26 to the power module 22, while at the same time recharging the batteries.

Referring now to FIGS. 21A and 21B, depicted therein at 430 therein is a hub module that may be used as part of a power system of the present invention. The example hub module 430 is constructed to be compatible with the power module 22, AC module 24, DC module 26, and/or battery module 420 described above.

The example hub module 430 comprises a hub output connector 432, a hub input connector 434, and/or a plurality of USB connectors 436a, 436b, and 436c. Within the hub module 430 is circuitry that interconnects the USB connectors 436a, 436b, and 436c such that electronic devices electrically connected to these connectors 436a, 436b, and 436c may receive power from the hub module 430.

To provide power to the circuitry within the hub module 430, the hub input connector 434 is configured to receive the second power connector 172 of the AC module 24 and/or the third power connector 282 of the DC module 26. In addition, the hub input and output connectors 432 and 434 may be configured such that circuitry within the USB hub module 430 passes the output of the AC module 24 and/or the output of the DC module 26 through to the power module 22.

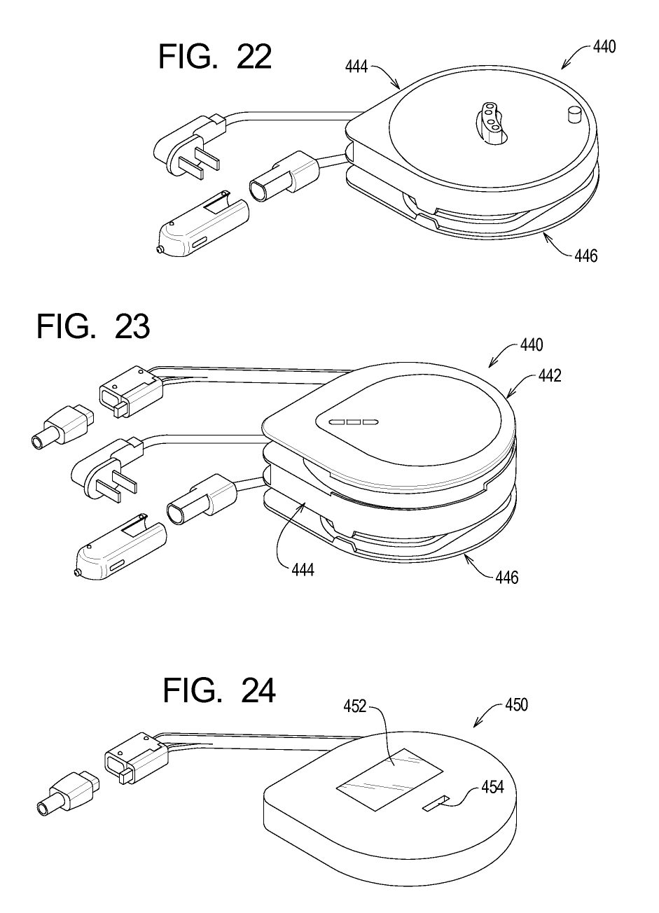

FIGS. 22 and 23 illustrate another example power system 440 comprising a power module 442, an AC module 444, and a DC module 446. The example power system 440 differs from the example power system 20 described above in that, like the battery module 420 and hub module 430 described above, the AC module 444 and/or DC module 446 are provided with input and output connectors. When the system 440 is in not in use, the input and output connectors on the AC module 444 and/or the DC power module 446 may be used to attach these modules 444 and 446 together, and to the power module 442, so that the three modules 442, 444, and 446 may be stored or used together.

When the system 440 is in use, the power module 442 may be provided with circuitry that selects an input power signal from either the AC module 444 or the DC power module 446. In this case, the intermediate module closest to the power module 442 (i.e., the AC module 444 in FIG. 23) can be configured to pass through the signal from the module distal from the power module 442 (i.e., the DC module 446 in FIG. 23).

Turning now to FIG. 24 of the drawing, depicted at 450 therein is another example of a power module that may be used with a power system of the present invention. In addition to the features of the power module 22 described above, the example power module 450 is provided with user interface hardware 452 in the form of a touch screen and a communications connector 454. The communications connector 454 may be connected to an electronic device such as an iPod or iPhone (not shown) that can be remotely controlled. A cable (not shown) between the communications connector 454 and the electronic device can carry both a power signal and a data signal, and the circuitry within the power module 450 can be configured to allow the electronic device to be controlled through the user interface hardware 452.

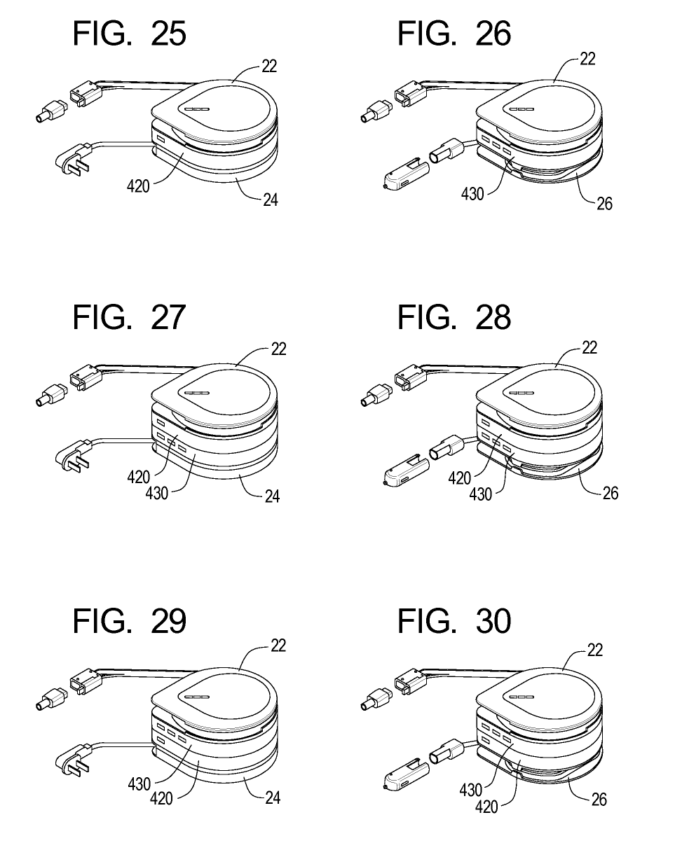

Referring now to FIGS. 25-30, depicted therein are a number of possible configurations available with the power module 22, AC module 24, DC module 26, battery module 420, and hub module 430 as described above.

In FIG. 25, power is supplied by the AC module 24, and the battery module 420 is arranged between the AC module 24 and the power module 22. The battery module 420 can be charged by the AC module 24 and can act as an uninterruptible power supply should AC power supplied to the AC module 24 fail. The DC module 26 may be substituted for the AC module 24.

In FIG. 26, power is supplied by the DC module 26, and the hub module 430 is arranged between the DC module 26 and the power module 22. In this case, the hub module 430 obtains power from the DC module 26 and passes power from the DC module 26 through to the power module 22. The AC module 24 may be substituted for the DC module 26 in the configuration depicted in FIG. 26 with similar effect.

In FIG. 27, power is supplied by the AC module 24, and the hub module 430 and the battery module 420 are arranged in that order between the AC module 24 and the power module 22. The hub module 430 obtains power from the AC module 24 and/or the battery module 420 and passes power through to the power module 22. The battery module 420 can be charged by the AC module 24.

In FIG. 28, power is supplied by the DC module 26, and the hub module 430 and the battery module 420 are arranged in that order between the DC module 26 and the power module 22. The hub module 430 obtains power from the DC module 26 and passes this power through to the power module 22. The battery module 420 can be charged by the DC module 26.

In FIG. 29, power is supplied by the AC module 24, and the battery module 420 and the hub module 430 are arranged in that order between the AC module 24 and the power module 22. The battery module 420 can be charged by the AC module 24 and can act as an uninterruptible power supply should AC s power supplied to the AC module 24 fail. The hub module 430 obtains power from the AC module 24 and passes power through to the power module 22.

In FIG. 30, power is supplied by the DC module 26, and the battery module 420 and the hub module 430 are arranged in that order between the DC module 26 and the power module 22. The battery module 420 can be charged by the DC module 26 and can act as an uninterruptible power supply should DC power supplied to the DC module 26 fail. The hub module 430 obtains power from the DC module 26 and passes power through to the power module 22.

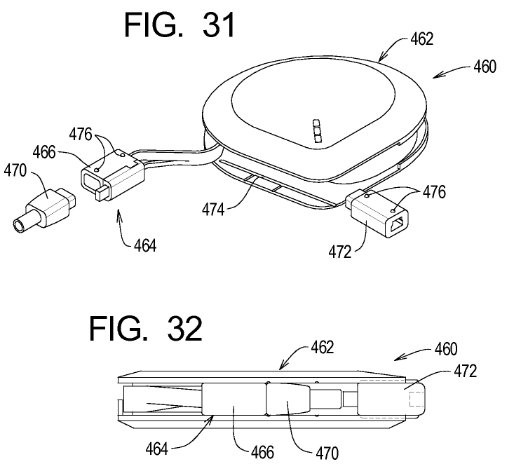

Referring now to FIGS. 31 and 32, depicted therein is another example power module 460 constructed in accordance with, and embodying, the principles of the present invention. The example power module 460 is in most respect similar to the power module 22 described above and will be described herein only to the extent that the module 460 differs from the power module 22.

As indicated above with respect to the power module 22, more than one adapter may be provided, and typically will be provided, to allow power to be supplied to a wide range of electronic devices with different styles of power connectors. In FIGS. 31 and 32, the power module 460 comprises a housing assembly 462 and a connector assembly 464 comprising connectors 466 and 476 and first and second adapters 470 and 472. A pair of parallel spaced docking slots 474 is formed on the housing assembly 462 (only one docking slot is visible in the drawing in FIG. 31). Docking projections 476 are formed on the cable connector 466 and on the second adapter 472.

To store the cable connector 466 and the first and second adapters 470 and 472, as shown in FIG. 32, the first adapter 470 is attached to the cable connector 466, the cable connector 466 is displaced such that the docking projections 476 on the cable connector 466 engage the docking slots 474, and the second adapter 472 is displaced such that the docking projections 476 on the second adapter 472 engage the docking slots 474.

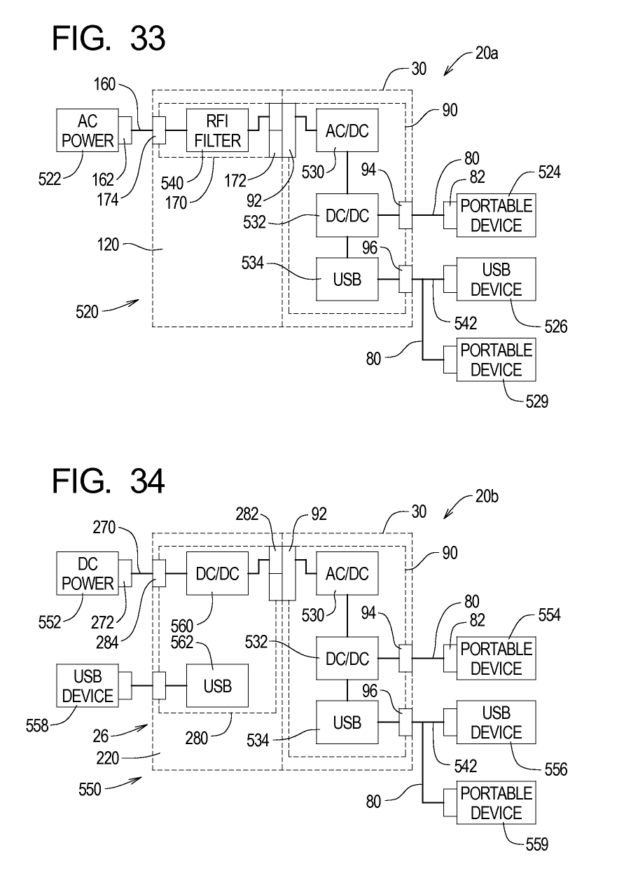

Turning now to FIGS. 33, 34, 35, and 36 of the drawing, depicted therein are block diagrams illustrating examples of circuits that may formed by several example configurations of power systems constructed in accordance with the principles of the present invention.

FIG. 33 depicts a first circuit 520 that is formed when the power supply 20 is arranged in the first example configuration 20a as described above with reference to FIGS. 1 and 18. This circuit 520 employs the AC module 24 and the power module 22 to connect an AC power source 522 to a portable electronic device 524, a USB device 526, and/or a portable device 529. The example first circuit board 90 comprises an AC/DC converter 530, a DC/DC regulator 532, and a USB power supply 534. The example second circuit board 170 comprises an RFI filter 540. A USB cable 542 is connected between the USB connector 96 and the USB device 526. The RFI filter 540 is connected between the cable connector 174 and the second power connector 172. The AC/DC converter 530 is connected between the first power connector 92 and the DC/DC regulator 532. The DC/DC regulator 532 is connected to the cable connector 94.

FIG. 34 shows that, in the second configuration 20b as described above with reference to FIGS. 2 and 19, a circuit 550 is formed. The circuit 550 uses the DC module 26 and the power module 22 to connect a DC power source 552 to a portable device 554, a first USB device 556, a second USB device 558, and/or a portable device 559. FIG. 34 illustrates that the DC module comprises a DC/DC regulator 560 and a USB power supply 562. The DC/DC regulator 560 is connected between the cable connector 284 and the third power connector 282. The DC/DC regulator 560 is further connected to the USB power supply 562.

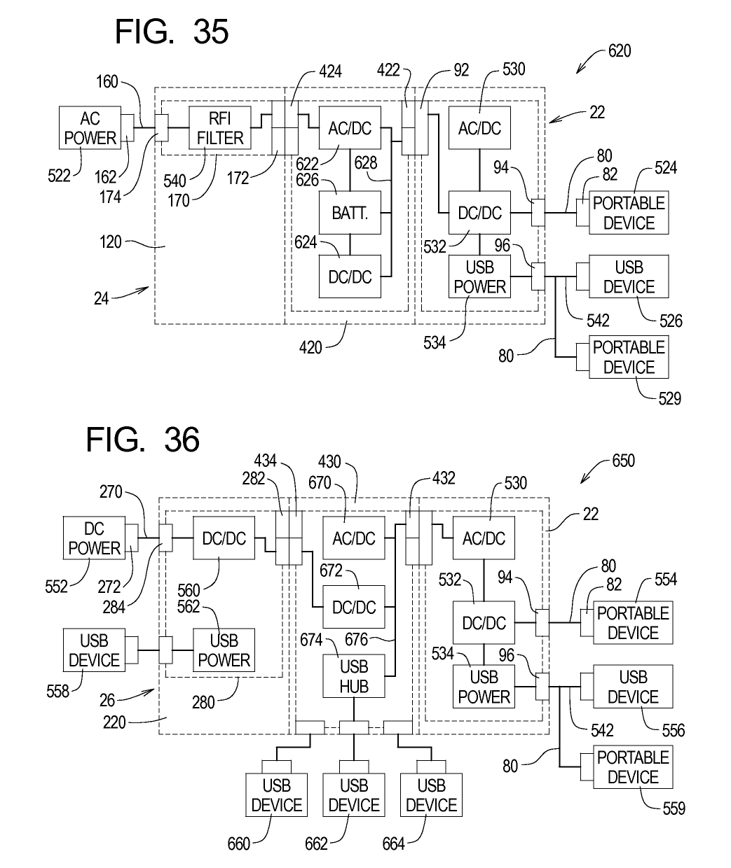

FIG. 35 illustrates a circuit 620 that uses the battery module 420, the AC module 24, and the power module 22 to connect the AC power source 522 to some or all of the portable device 524, the USB device 526, and the portable device 529. In this example, the battery module 420 comprise an AC/DC converter 622, a DC/DC regulator 624, and a battery 626 all connected to a DC bus 628. In this configuration, the DC bus 628 is connected to the battery output connector 422, and the AD/DC converter 622 is connected between the battery input connector 424 and the DC bus 628.

FIG. 36 illustrates a circuit 650 that uses the hub module 430, the DC module 26, and the power module 22 to connect the DC power source 552 to any one or combination of the portable device 554, the USB device 556, and the USB device 558, the portable device 559, and USB devices 660, 662, and 664. In this example, the hub module 430 comprise an AC/DC converter 670, a DC/DC regulator 672, and a USB hub device 674 all connected to a DC bus 676. In this configuration, the DC/DC regulator 672 supplies power to the USB hub device 674, which in turn provides power to and allows communication among the USB devices 660, 662, and 664.

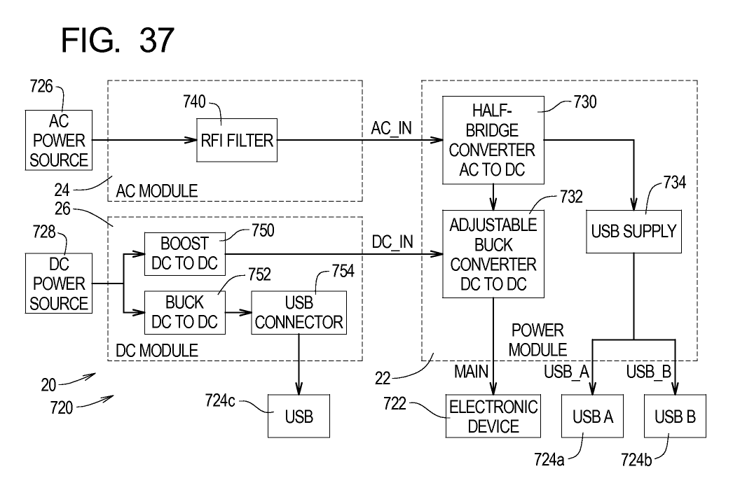

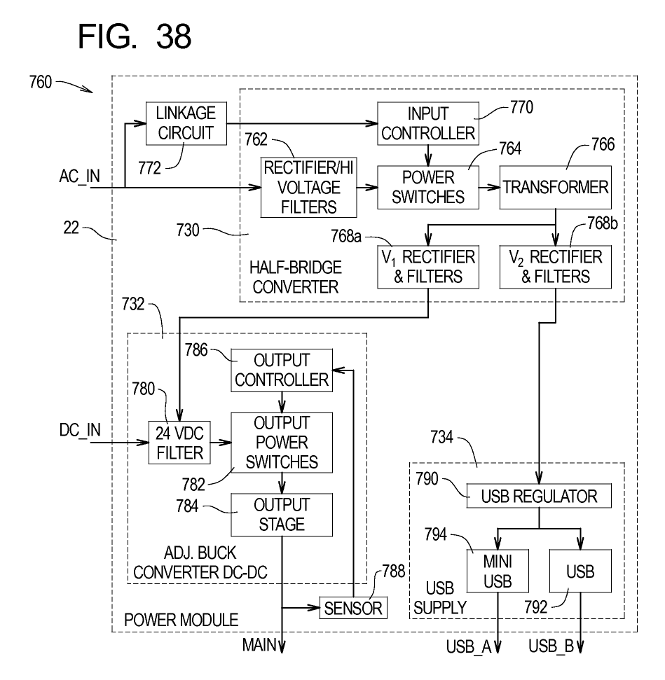

FIGS. 37 and 38 contain block diagrams illustrating an example circuit 720 that may be employed to implement the power system 20 described above. As illustrated in FIG. 37, the circuit 720 is adapted to provide power to an electronic device 722, and one or more USB devices 724a, 724b, and/or 724c, based on either an AC power source 726 or a DC power source 728.

The power module 22, AC module 24, and DC module 26 forming the power system 20 are illustrated with broken lines in FIG. 37. As shown, the example circuit forming the power module 22 comprises a half-bridge converter (AC to DC) 730, an adjustable buck converter 732, and a USB supply 734. The AC module 24 is depicted with an example circuit comprising an RFI filter 740. The example circuit employed by the DC module 26 comprises a boost converter (DC to DC) 750, a buck converter (DC to DC) 752, and a USB connector 754.

When the AC module 24 is connected to the power module 22, the AC signal from the power source 726 is filtered by the RFI filter 740 to obtain a signal identified as AC_IN in FIGS. 37 and 38. The AC_IN signal is input to the half-bridge converter 730, which converts the AC_IN signal to a DC signal. The output of the half-bridge converter 730 is fed to the adjustable buck converter 732. Based on the output of the half-bridge converter 730, the adjustable buck converter 732 generates a MAIN signal appropriate for powering the electronic device 722. The half-bridge converter 730 also generates a power signal to appropriate for powering the USB supply 734, which generates signals appropriate for powering the USB A and USB B devices 724a and 724b.

When the DC module 26 is connected to the power module 22, the DC signal from the DC power source 728 is fed to the boost converter 750 and the buck converter 752. The boost converter 750 generates a DC_IN signal that is fed to the adjustable buck converter 732. Based on the DC_IN signal, the adjustable buck converter 732 generates the MAIN signal appropriate for powering the electronic device 722. The buck converter 752 generates a power signal appropriate for the USB device 724c through the USB connector 754.

Turning now to FIG. 38, an example circuit 760 for implementing the power module 22 will now be described. The example circuit 760 illustrates that the half-bridge converter 730 comprises an input rectifier/filter 762, power switches 764, a transformer 766, a first output rectifier/filter 768a, and a second output rectifier/filter 768b, and an input controller 770 for controlling the power switches 764. The controller controls the power switches based on such factors as start-up mode, DC power level required, and/or state of the AC_IN signal as detected by a linkage circuit 772. As is known in the art, the half-bridge converter circuit 730 can be configured such that the first and second output rectifier/filter circuits 768a and 768b generate two DC power signals of different voltage levels.

The output of the first rectifier filter circuit 768a is input to the adjustable buck converter 732. In particular, both the output of the first rectifier circuit 768a and the DC_IN signal are input to a filter circuit 780. The output of the filter circuit 780 is fed to output power switches 782 and then to an output stage 784. An output controller 786 operates the output power switches 782 and the output stage 784 forms an energy device that results in the MAIN signal being a DC power signal at a level determined by the operation of the output switches 782. A sensor 788 may be used to form a feedback loop with the output controller 786 to improve regulation of the MAIN signal.

The output of the second rectifier filter circuit 768b is input to the USB supply 734. In particular, the USB supply comprises a USB regulator 790, a USB connector 792, and a mini USB connector 794. The USB_A and USB_B signals are present at the connectors 792 and 794, respectively.

From the foregoing, it should be apparent that the present invention may be embodied in forms other than those exact forms described above. Accordingly, the scope of the present invention should be determined by the claims appended hereto and not the foregoing detailed description of examples of the invention.

What is claimed is:

1. A power supply for an electronic device comprising:
a power module comprising a first housing assembly, an output cable assembly, and a first power connector;
an AC module comprising a second housing assembly, an AC cable assembly, and a second power connector; and
a DC module comprising a third housing assembly, a DC cable assembly, and a third power connector; wherein the power supply operates in a first configuration in which
the first and second housing assemblies are detachably attached such that the first and second power connectors are electrically connected,
an AC power signal present on the AC cable assembly is transmitted to the power module through the first and second power connectors,
the power module generates a DC output signal on the output cable assembly based on the AC power signal transmitted through the first and second power connectors, and
the output cable assembly is electrically connected to the electronic device; and
a second configuration in which
the first and third housing assemblies are detachably attached such that the first and third power connectors are electrically connected,
a DC power signal present on the DC cable assembly is transmitted to the DC power module through the first and third power connectors,
the power module generates the DC output signal on the output cable assembly based on the DC power signal transmitted through the first and third power connectors, and
the output cable assembly is electrically connected to the electronic device.

2. A power supply as recited in claim 1, in which the first housing assembly defines a perimeter slot adapted to receive at least a portion of the output cable assembly.

3. A power supply as recited in claim 2, in which:
at least one docking slot is formed on the first housing assembly within the perimeter slot; and
at least one docking projection is formed on a connector portion of the output cable assembly; wherein
the docking slot receives the docking projection to detachably attach the connector portion to the first housing assembly.

4. A power supply as recited in claim 2, in which:
at least one docking slot is formed on the first housing assembly within the perimeter slot; and
at least one docking projection is formed on and adapter portion of the output cable assembly; wherein
the docking slot receives the docking projection to detachably attach the adapter portion to the first housing assembly.

5. A power supply as recited in claim 1, in which the second housing assembly comprises a base part, a retainer part, and a tray assembly, wherein:
the tray assembly is rotatably supported by the base part and the retainer part; and
at least a portion of the AC cable assembly is supported within the tray assembly such that rotation of the tray assembly relative to the base part retracts the AC cable assembly within the second housing assembly.

6. A power supply as recited in claim 5, in which the tray assembly defines a handle projection and the first housing assembly defines a handle to opening adapted to receive the handle projection when the power supply is in the first configuration.

7. A power supply as recited in claim 1, in which the third housing assembly defines a perimeter slot adapted to receive at least a portion of the DC cable assembly.

8. A power supply as recited in claim 1, in which the first, second, and third housing assemblies define complementary shapes.

9. A power supply as recited in claim 8, in which:
the shapes of the first and second housing assemblies may be aligned when the power supply is in the first configuration; and
the shapes of the first and third housing assemblies are aligned when the power supply is in the second configuration.

10. A power supply as recited in claim 1, further comprising a battery module defining a battery housing assembly, a battery, and a first battery connector, where the power supply operates in a battery configuration in which:
the first housing assembly and the battery housing assembly are detachably attached such that the first power connector and the first battery connector are electrically connected,
a DC power signal generated by the battery is transmitted to the power module through the first power connector and first battery connector,
the power module generates the DC output signal on the output cable assembly based on the DC power signal transmitted through the first power connector and the first battery connector, and
to the output cable assembly is electrically connected to the electronic device.

11. A power supply as recited in claim 10, in which the battery module further defines a second battery connector, where the power supply operates in an AC charge configuration in which:
the second housing assembly and the battery housing assembly are detachably attached such that the second power connector and the second battery connector are electrically connected,
an AC power signal present on the AC cable assembly is transmitted to the battery module through the second power connector and the second battery connector,
the battery module charges the battery based on the AC power signal transmitted through the second power connector and the second battery connector.

12. A power supply as recited in claim 10, in which the battery module further defines a third battery connector, where the power supply operates in a DC charge configuration in which:
the third housing assembly and the battery housing assembly are detachably attached such that the third power connector and the second battery connector are electrically connected,
a DC power signal present on the DC cable assembly is transmitted to the battery module through the third power connector and the second battery connector,
the battery module charges the battery based on the DC power signal transmitted through the third power connector and the second battery connector.

13. A power supply as recited in claim 1, further comprising a hub module defining a hub housing assembly, a hub circuit, a first hub connector, and a second hub connector, where the power supply operates in a hub configuration in which:
the first housing assembly and the hub housing assembly are detachably attached such that the first power connector and the first hub connector are electrically connected, and
the hub module generates at least one USB output signal.

14. A power supply as recited in claim 1, in which the power module comprises:
an AC to DC converter for converting the AC power signal transmitted through the first and second power connectors into the DC output signal; and
a DC to DC converter for converting the DC power signal transmitted through the first and third power connectors into the DC output signal.

15. A power supply as recited in claim 14, in which the AC module comprises a filter circuit for filtering the AC power signal present on the AC power cable.

16. A power supply as recited in claim 14, in which the DC module comprises a boost converter for converting the DC power signal present on the DC cable assembly into the DC power signal transmitted through the first and third power connectors.

17. A power supply as recited in claim 1, in which:
the power module comprises:
an AC to DC converter for converting the AC power signal transmitted through the first and second power connectors into the DC output signal; and
a DC to DC converter for converting the DC power signal transmitted through the first and third power connectors into the DC output signal;
the AC module comprises a filter circuit for filtering the AC power signal present on the AC power cable; and
the DC module comprises a boost converter for converting the DC power signal present on the DC cable assembly into the DC power signal transmitted through the first and third power connectors.

18. A power supply for an electrical device comprising
a power module comprising:
a first housing assembly,
an output cable assembly,
a first power connector, and
at least one first circuit board containing
an AC to DC converter operably connected between the first power connector and the output cable assembly, and
an AC to DC converter operably connected between the first power connector and the output cable assembly;
an AC module comprising
a second housing assembly,
an AC cable assembly,
a second power connector, and
at least one second circuit board containing a filter circuit operably connected between the AC cable assembly and the second power connector; and
a DC module comprising
a third housing assembly,
a DC cable assembly,
a third power connector; and
at least one third circuit board comprising a boost converter operably connected between the DC cable assembly and the third power connector;
wherein the power supply operates in
a first configuration in which
the first and second housing assemblies are detachably attached such that the first and second power connectors are electrically connected,
an AC power signal present on the AC cable assembly is transmitted to the power module through the first and second power connectors,
the AC to DC converter generates a DC output signal on the output cable assembly based on the AC power signal transmitted through the first and second power connectors, and
the output cable assembly is electrically connected to the electronic device; and
a second configuration in which
the first and third housing assemblies are detachably attached such that the first and third power connectors are electrically connected,
a DC power signal present on the DC cable assembly is transmitted to the DC power module through the first and third power connectors,
the DC to DC converter generates the DC output signal on the output cable assembly based on the DC power signal transmitted through the first and third power connectors, and
the output cable assembly is electrically connected to the electronic device.

19. A power supply as recited in claim 18, in which the first, second, and third housing assemblies define complementary shapes.

20. A power supply as recited in claim 19, in which:
the shapes of the first and second housing assemblies may be aligned when the power supply is in the first configuration; and
the shapes of the first and third housing assemblies are aligned when the power supply is in the second configuration.

21. A power supply for an electronic device comprising:
a power module comprising a power housing assembly, an output cable assembly, and a primary power connector; and
an AC module comprising an AC housing assembly, an AC cable assembly, and a AC power connector; wherein the power supply operates in
an AC configuration in which
the power and AC housing assemblies are detachably attached such that the primary and AC power connectors are electrically connected,
an AC power signal present on the AC cable assembly is transmitted to the power module through the primary and AC power connectors,
the power module generates a DC output signal on the output cable assembly based on the AC power signal transmitted through the primary and AC power connectors, and
the output cable assembly is electrically connected to the electronic device

22. A power supply for an electronic device comprising:
a power module comprising a power housing assembly, an output cable assembly, and a primary power connector; and
a DC module comprising a DC housing assembly, a DC cable assembly, and a DC power connector; wherein the power supply operates in
a DC configuration in which
the primary and DC housing assemblies are detachably attached such that the primary and DC power connectors are electrically connected,
a DC power signal present on the DC cable assembly is transmitted to the power module through the primary and DC power connectors,
the power module generates the DC output signal on the output cable assembly based on the DC power signal transmitted through the primary and DC power connectors, and
the output cable assembly is electrically connected to the electronic device.

23. A power supply for an electronic device comprising:
a power module comprising a power housing assembly, an output cable assembly, and a primary power connector; and
a battery module defining a battery housing assembly, a battery, and a first battery connector, where the power supply operates in a battery configuration in which:
the power housing assembly and the battery housing assembly are detachably attached such that the primary power connector and the first battery connector are electrically connected,
a DC power signal generated by the battery is transmitted to the power module through the primary power connector and first battery connector,
the power module generates the DC output signal on the output cable assembly based on the DC power signal transmitted through the primary power connector and the first battery connector, and
the output cable assembly is electrically connected to the electronic device.
